(19) United States
(12) Patent Application Publication
(10) Pub. No.: US 2005/0031838 A1
(43) Pub. Date: Feb. 10, 2005

(54) Taggant security system for paper products as a deterrent to counterfeiting

(75) Inventors: John G. Lagunowich, Marshfield, MA (US); Tim Driscoll, Pautucket, RI (US); William D. Lilly, Providence, RI (US); Paul Doll, Canton, MA (US)

Correspondence Address: HARRINGTON & SMITH, LLP, 4 RESEARCH DRIVE, SHELTON, CT, 06484-6212, US

(73) Assignee: Spectra Systems Corporation

(21) Appl. No.: 10/912,379

(22) Filed: Aug. 5, 2004

Related U.S. Application Data
(60) Provisional application No. 60/493,177, filed on Aug. 6, 2003.
(60) Provisional application No. 60/544,175, filed on Feb. 12, 2004.

(51) Int. Cl. B32B 3/00

(52) U.S. Cl. 428/211.1

(57) ABSTRACT

A taggant security system for preventing the counterfeiting of goods associated with a paper product is provided. The taggant security system includes a paper product coating located on a paper product. The paper product coating is preferably one which is commonly used in the paper making industry. The taggant security system further includes one or more taggants incorporated within said paper product coating for authenticating said paper product. In preferred embodiments, the paper product coating is either a clay or starch coating. In addition, in preferred embodiments, the paper product is either a single or multi-ply packaging board or a label stock.

This patent application claims priority under 35 U.S.C. §119(e) to U.S. Provisional Application Ser. No. 60/493,177 filed Aug. 6, 2003; and, U.S. Provisional Application Ser. No. 60/544,175 filed Feb. 12, 2004. The disclosures of these applications are incorporated by reference in their entirety herein.

### BACKGROUND OF THE INVENTION

1. Field of the Invention

The invention relates to security taggants for deterring counterfeiting, piracy and/or diversion. More particularly, the invention relates to security taggants systems applied to paper products, e.g. packaging board or label stock as a deterrent to counterfeiting goods or products of value which are labeled and/or packaged by the tagged paper product.

2. Prior Art

With the cost of counterfeit goods exceeding $600 billion annually, manufacturer's of pharmaceuticals, cigarettes, and other value items need new security approaches to protect their goods from piracy or diversion. The amount of losses due to counterfeit goods is expected to rise even further and is creating additional concerns with the continued discovery of terror groups using counterfeit groups items to fund their activities. In addition, with the dramatic increase in the sale of pharmaceuticals and goods over the internet manufacturers need to be able to both protect their items and demonstrate that counterfeit goods which often are packaged to look like the genuine item are indeed fraudulent.

In order to combat the above problems, taggant based security features for authenticating paper documents, packaging and items of value are currently being used in the art. Typical taggants used are fluorescent security dyes, phosphors, or pigments and are usually located in the ink used on the paper substrate or the paper substrate itself. However, these security ink systems are susceptible to attack by the use of materials with a similar appearance printed in an identical manner.

Other taggant security systems used in the art generally consist of either visible or invisible fluorescent security features for authenticating the paper documents. In these security schemes, the authenticity of the item is confirmed by the activation of the fluorescent feature by a particular band of wavelengths and the subsequent detection of the proper fluorescence wavelength band with the naked eye or by electronic detection. Generally, in these security schemes, the taggants are employed in a manner where solely the wavelengths of their emission are observed for authentication. Further, in many of these approaches long Ultraviolet (UV) excitation is used to activate the fluorescence of materials of materials which have no body color. The preferred materials lack a visible body color and can be printed or applied in such a manner as to minimize attention to the feature. There are also more complex taggants security schemes for authenticating paper goods such as described U.S. Pat. No. 4,451,530 to Kaule et al, which relates to security paper with authenticity features in the form of luminescing substances.

Despite the above security technologies, there is still a need in the art for a cost effective taggant security system for packaging products, e.g. a packaging board or label stock, which provides an added measure of security over typically ink/taggant systems known in the art. Applying a security feature to the underlying substrate enables the creation of multi-layered security features where security taggants may exist in both the underlying board or paper and in the inks printed on top. Such a scheme raises the technical and economic barrier for those attempting to counterfeit the item.

### SUMMARY OF THE INVENTION

The present invention achieves the above needs in the art by providing a taggant security system for paper products which makes the paper products which label and/or package a particular item more difficult to duplicate or counterfeit. The present invention improves the security of the item in a more effective manner than the typical prior art taggant systems do, while at the same time also being cost effective. The taggant system of the present invention makes the paper products which label and/or package a particular item more difficult to counterfeit or duplicate by having its taggants incorporated into the clay or starch coating commonly used in the paper making business for opacity, gloss, and improved printability to the paper products. In many of the prior art security systems, the taggants are located solely in the ink on top of the paper or alternatively the taggants are located in the paper substrate itself, thereby making these products susceptible to duplication by similar materials printed in a conventional manner by sophisticated printing devices. In contrast, in the present invention by having the taggants incorporated in the paper coatings used on the paper products, it makes it significantly more difficult for a counterfeiter to duplicate these paper products. One reason for the increased difficulty in duplicating the paper product, is that the addition of taggants into a clay or starch paper coating results in a mottled appearance of the fluorescence intensity. In other words, the fluorescence intensity given off by the taggants in the paper product coatings appears non-uniform upon close inspection. This method of incorporation results in a bright, uniform fluorescence on a large scale, but when the board is inspected more closely spatial differences can be seen in the brightness of the fluorescence. Attempts to mimic this appearance using printing techniques could easily be distinguished by the raster pattern of the printing solution used to create this same visual effect.

It is further noted that the taggants do not in any way alter the normal functioning of the paper product coating. Moreover, the paper product coating does not in any way alter the normal functioning of the taggants incorporated therein.

In another embodiment, the taggants can be included in or between layered structures of a paper product, e.g. multi-ply packaging board, via the paper product/taggant coating.

As a further added measure of security in certain embodiments of the present invention, the taggants are not only incorporated into the paper product coatings, but these taggants in the paper product coating also interact with absorbing pigments and/or taggants in the ink located on the top of the paper product coating to produce a detailed fluorescence signature, thereby making the paper product even more difficult to duplicate. In yet another embodiment, the taggants may interact with absorbing pigments and/or taggants in the ink printed on top of the coating, without having any taggants incorporated in the coating to also produce detailed a unique fluorescence signature.

Besides providing an added measure of security over typical taggant security for authenticating paper products used in the prior art, the taggant system of the present invention, as mentioned above, is also cost effective. It is cost effective is because its provides a security feature that is consistent with the manufacturing of the item or its packaging without requiring any additional manufacturing steps or reducing the manufacturing speed for the material. Also, by having the security taggant system of the present invention consistent with the manufacturing of the item or its associated packaging, the taggant system can be inspected without actually having to open the item or even remove it from the point of sale. Moreover, the security taggants of the security system of the present invention can be readily identified either by a special lamp and visual inspection or by the use of hand held reader devices, thereby providing a manufacturer with the ability to secure the packaging substrate in a manner similar to the protection of the substrate of fiduciary items. In major industries such as pharmaceutical or tobacco industries, all of the above characteristics are highly desirable.

In accordance with the present invention, a taggant security system for preventing the counterfeiting of goods associated with a paper product having a substrate is provided. The taggant security system includes a paper product coating which is located on the substrate of the paper product. The taggant security system further includes one or more taggants incorporated within the paper product coating. In preferred embodiments, the paper product coating is either a clay or starch coating. In addition, in preferred embodiments, the paper product is either single or multi-ply packaging board or a label stock. The paper product coating is also preferably a coating commonly used in the paper making industry for providing the following characteristics to a paper product, including but not limited to opacity, gloss and/or improved printabilty for the paper product.

In another aspect of the present invention, a taggant security system for authentication of a multi-ply packaging board is provided. The taggant security system comprises a coating having one or more taggants incorporated therein. The coating is located in an area either in or between said multi-ply packaging board. In preferred embodiments, the coating is a starch coating. In certain preferred embodiments, the coating is applied in between the paper product using a spray boom. In other preferred embodiments the coating is applied within the paper product using a dip tank.

In another aspect of the present invention, an interacting taggant security system for preventing the counterfeiting of goods associated with a paper product is provided. The interacting taggant security system includes a paper product coating located on the paper product and one or more taggants incorporated within the paper product coating. Further, the interacting taggant security system also includes at least one ink having one or more pigments therein, with the at least one ink located on top of the paper product coating. The one or more pigments in said ink interact with said one or more taggants incorporated within the paper product coating, thereby creating a unique spectral emission which would not have been created otherwise but for the interaction. In one preferred embodiment, one or more flouresecent pigments in the ink interact with the one or more taggants in the paper product coating by at least partially absorbing the fluorescence emitted by the one or more taggants incorporated in the paper product coating. The fluorescence which is at least partially absorbed by the absorbing pigments causes a second fluorescence to be emitted by the one or more absorbing pigments, thereby creating a unique spectral emission. In another preferred embodiment, at least one absorbing non-fluorescent pigment is added to the above ink/coating system to further alter the unique spectral emission.

In another aspect of the present invention, an interacting taggant security system for preventing the counterfeiting of goods associated with a paper product is provided. The interacting taggant security system includes at least one ink located on a paper substrate of said paper product. The ink has one or more pigments located therein. In addition, the interacting taggant security system includes one or more taggants located within the ink. The one or more pigments in the ink interact with the one or more taggants in the ink, thereby creating a unique spectral emission which would not have otherwise been created but for the interaction. In one preferred embodiment, one or more fluorescent pigments in the ink interact with the one or more taggants in the ink by at least partially absorbing the fluorescence emitted by the one or more taggants in the ink. The fluorescence which is at least partially absorbed by the absorbing pigments causes a second fluorescence to be emitted by the one or more fluorescent pigments, thereby creating a unique spectral emission. In another preferred embodiment, at least one absorbing non-fluorescent pigment is added to the above ink system to further alter the unique spectral emission.

In yet another aspect of the present invention, a method for preparing a taggant security system for authenticating a paper product is provided. The method includes preparing a preparation of one or more taggants for incorporation into a paper product coating that is used in the paper making industry. The next step includes incorporating the taggant preparation into the paper product coating itself. In other embodiments, the paper product coating is applied to the paper product; and the paper product is then authenticated.

### BRIEF DESCRIPTION OF THE DRAWINGS

FIG. 1: Cross sectional view of a typical single ply packaging board having a clay coating located on the top side of the board;

FIG. 2: illustrates a representative UV fluorescence spectrum of an orange fluorescing security material;

FIG. 3 is a cross sectional view of a 3 ply board prior to assembly, wherein a phosphor taggant has been applied as a starch coating onto the middle ply;

FIG. 4 illustrates a complicated emission spectrum created under long UV excitation of a red fluorescent fluorophor printed on top of a long UV fluorescent doped clay board;

FIG. 5 illustrates a complicated emission spectrum created under long UV excitation of an embodiment in which a yellow pigment was added to the same magenta ink printed onto the same doped clay board depicted in FIG. 4;

FIG. 6 illustrates a complicated emission spectrum created under long UV excitation of a red fluorescent fluorophor of an ink alone embodiment of the present invention; and

FIG. 7 illustrates a complicated emission spectrum created under long UV excitation of an ink alone embodiment in which a yellow pigment was added to the same magenta ink depicted in FIG. 6.

### DETAILED DESCRIPTION OF THE INVENTION

As a deterrent to counterfeiting, piracy, or diversion, we present the use of security taggants, such as fluorescent inks, phosphors, polymer fibers or particles, and other indicia, in a unique and cost effective manner to provide an added measure of security as compared to typical ink/taggant systems known in the art. In particular, in certain embodiments these taggants are incorporated into one or more paper coating layers typically used in the paper making process for opacity, durability and/or printability, such as clay or starch coatings. These paper product coatings of the present invention having the taggants incorporated therein are applied to either and/or both sides of a paper product e.g. a packaging board stock or label stock. In another embodiment, the taggants can be included in or between layered structures of a paper product, e.g. multi-ply packaging board, via the paper product/taggant coating. In a further embodiment, an added measure of security is provided by having taggants in the paper coating interact with fluorescent absorbing pigments and/or absorbing taggants in the ink printed on top of the paper coating, thereby forming a detailed fluorescence signature which can be analyzed by a spectrometer based or spectrally based or spectrally sensitive (combination of narrow band pass filters and photodetectors) reader. In yet another embodiment, the interaction of the taggants with other taggants and/or pigments is limited to the ink only, without the placement of any taggants in the paper coating. A more detailed description of each of these embodiments of the security taggant system of the present invention is set forth below.

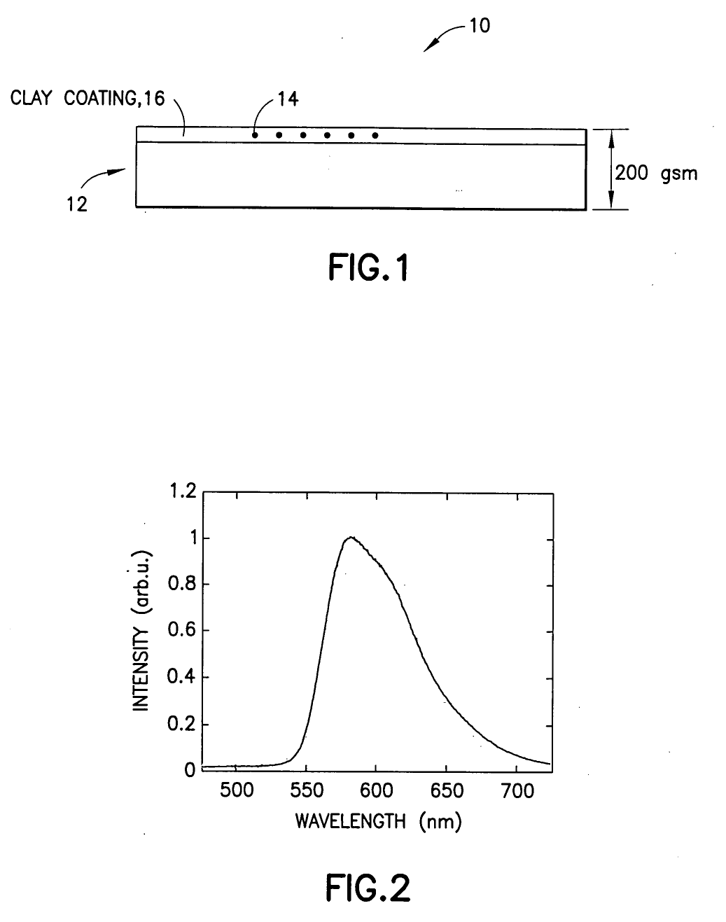

Specifically, FIG. 1 illustrates a taggant security coating system 10 of a first embodiment of the present invention. The taggant security coating system 10 includes a paper product 12, at least one type of security taggant 14 and a paper product coating 16 for including the at least one taggant therein. The paper product 12 may include any type of paper good of value but for the purposes of the present invention mainly relates to label stock (e.g. adhesive labels for bottles), packaging board (e.g. for pharmaceuticals, tobacco, other industries with goods of value, etc.). In the first embodiment depicted in FIG. 1, the paper product 12 is a typical packaging board construction. The total basis weight of the sample board 12 construction is 200 grams per square meter (200 gsm). The board 12 may consist of a single ply or multiple ply construction.

The paper product coating 16 is a coating commonly used in the paper making industry, such as a clay or a starch coating. Further, the coating 16 may be present in an amount varying from 2-16 gsm. For example in the first embodiment depicted in FIG. 1, the coating is a clay coating. The clay coating 16 is preferably comprised of either kaolin or calcium carbonate based clays commonly used in the paper making industry for opacity, gloss, and improved printability of the paper product. The above clay coatings 16 are provided as kaolin or calcium carbonate slurries with solid concentrations between 50 and 70%.

In general, the clays used for paper coatings 16 fall into three main categories based on the minerals that they contain. These categories include kaolin, ground calcium carbonate, and precipitated calcium carbonate. The ground calcium carbonate material is mined and then ground and treated prior to being added to the binders used to make the clay. Precipitated calcium carbonate is synthesized by reacting lime with carbon dioxide. Any other coatings used in the paper making industry for any of the above objectives may also be used in accordance with the present invention.

In the first embodiment of the present invention depicted in FIG. 1, the clay coating 16 was applied to the top side of the board. However, the coating 16 may be applied on the top or bottom side or both the top and bottom of the paper product. Also, multiple clay layers, usually not exceeding two, may be used. In the present embodiment the taggants may exist in just one of both of the layers. The total basis weight of the paper product 12 depicted in FIG. 1 is preferably 200 gsm with the clay coating weight of 2-16 gsm, included in that figure.

Next, the taggants 14 used in accordance with the present invention are optically responsive taggants which may be detected through the use of radiation extending from the short UW (˜200 nm) to the near IR (5 microns). The selected taggants 14 must be chemically compatible with the paper product coating 16, e.g. clay or starch coating and be operative at particle sizes of less than 10 microns, due to the fact that taggants having a size greater than 10 microns could not be effectively coated in practicing the present invention. The security taggants 14 can be visible or invisible fluorescent dyes or phosphors, up-converting phosphors, phosphorescent materials, and polymer particles such as spheres or fibers which contain fluorescent or non-fluorescent pigments which are either visible or free of any body color. Examples of each of the different types or class of taggants 14 which may be used in the taggant security systems of the present invention are discussed throughout the present application.

For example, the upconverting taggant materials 14 of the present invention are formed by incorporating either combinations of lanthamide ions, such as Yb3+/Er3+ (green emission) and Yb3+/Tm3+ (blue emission), or in some cases single lanthamide ions, such as Er3+ (red emission), into glass or crystal matrices. These materials are characterized by a visible emission extending from blue to red when excited by infrared (850-1500 nm) radiation.

In particular, in the first embodiment of the present invention depicted in FIG. 1, the taggants 14 incorporated into the clay coating are long UV fluorescent phosphor taggants that preferably include classes of low body color, organic, long UV fluorescent security pigments which emit bright visible colors under excitation at UV wavelengths of about 310 nm to about 390 nm. These security taggants 14 are able to blend into printing inks or coatings without affecting the color of the carrier. Effective security taggants 14 should have good chemical resistance to organic solvents, acids, and caustics and possess strong resistance to photo-degradation. Examples of some of these families include benzothiazoles, rare earth ion chelates such as Eu trifluoroacetate trihydrate, benzoxazins, and benzimidazoles.

Further, since it is desirous to keep the fluorescent materials in pigment form for improved chemical resistance and photo-stability, an aqueous dispersion should preferably be made to keep the maximum particle size suitable for use in the clay coating. In this regard, since the applied basis weight of the clay coating onto the board is often applied by the use of a doctor blade, maximum particle sizes for the taggants 14 must be less than 10 microns in order to avoid streaking in the coating. The taggants, e.g. long uv phosphor taggants which are incorporated into the clay coating preferably have a size range from about 0.01 microns to about 10 microns. Particle size can be controlled by the manufacturing of a milled dispersion following the recipe below. Set forth below is a preferred way of preparing the paper coating system 10 of the present invention.

Specifically, using a Netsczch TM-10 turbo mill, or a similar basket mill, a stable aqueous dispersion can be formed by combining the following materials and milling until a particle size distribution with a D99 (where 99% of the particles have a size that is equal or smaller) of less than 10 microns and a D50 (size at which half the particles in the distribution are either larger or smaller) of 1-2 microns is achieved:

The following loadings are preferably used in preparing the aqueous dispersion of the taggants 14, (e.g. long UV phosphors in this embodiment) for incorporation into the clay coating 16. The volume of the aqueous dispersion will depend upon the scale of the milling equipment. It could range range from a few ml to over 1000 liters. One skilled in the art would readily be able to determine the proper volume to use in preparing the aqueous dispersion containing the taggants. In addition, a biocide is used to protect the shelf life of the dispersion from the growth of biologicals. An example of the preferred ranges for the constituents of the loadings for the aqueous taggant dispersion is set forth below.

| | |
|---|---|
| Long UV Phosphor loading: | 10-60% (% of total weight) |
| Dispersing agent (polyvinyl alcohol) | 1-20% (% of taggant) |
| biocide (e.g. Proxe GXL) | .01-5% (% of total weight of |
| | dispersion) |

Other dispersants besides polyvinyl alcohol that could be used in the aqueous dispersion of the Long UV phosphor taggants include dispersants derived from mineral acids. Major families include the phosphate family, the silicate family, the aluminate family, and the borate family. These are salts that ionize into moderately weak acids (pKa>4). Examples are sodium hexametaphosphate, sodium n-silicate, sodium aluminate, sodium tetraborate, and tri-sodium phosphate.

Simple alkali soaps and sulfonates could also work as dispersants. Some examples are sodium adipate, and sodium caprylate.

Organic polyacid salts may also be used. They are more variable and versatile and can provide for a more stable dispersion but are typically more expensive. Some examples include polymer versions of sodium malonate, sodium succinate, sodium glutarate, sodium glutamate, sodium malate, sodium citrate, and sodium acrylate.

In addition to these anionic dispersants, non-ionic ones could also work. Examples are alkanolamines such as 2-amino-2-methyl-1-propanol, 2-amino-1-butanol, 2-amino-2-methyl-1,3-propanediol, and tris-(hydroxyl-methyl)-amino-methane.

The loading ranges for the dispersants or surfactants are 0.01-10% and preferably 0.1-4%.

Many commercially available biocides (bactericides/fungicides/algeacides) exist such as the Proxel™ series from Avecia and the Dowacil™ series from Dow Chemicals. Rohm and Haas provides series based on isothiazolone chemistry sold under the brand names aKathon™ and Neolone™. The the Mergal™, Polyphase™, and Troysan™ series from Troy, the Fungitrol™ and Nuosept™ series from ISP, and Arch Chemicals Zinc Omadine products can also provide protection against the growth of bacteria, fungae, and algae.

The final dispersion can be simply blade mixed into the clay coating 16 to create a final phosphor loading ranging from 0.01-10% with the loading level effecting the brightness of the fluorescence. Once the phosphor is incorporated into the clay 16 in this manner, the clay may be coated onto the board 12 following a process identical to that commonly used to apply taggant free paper clays onto paper products. It should be noted that many clay systems contain invisible, blue fluorescing optical brightening agents. Due to the prevalence of these materials, it is recommended that only long UV fluorescent security materials with emissions longer than 450 nm be selected in these instances.

Once the security taggant 14 is applied to the board, exciting the board with the appropriate excitation wavelengths and detecting the fluorescence emission can determine the authenticity of the board 12. Possible devices for exciting the board 12 include a fluorescent lamp or strobe system known in the art. If the material is a long or short UV excitable fluorophor the excitation can be preformed by a, standard UV light such as Mineralight™ lamp (model #uvgl-58) by UVP. A typical fluorescence spectra of an orange fluorescent system is shown in FIG. 2. The fluorescence spectra can be captured by a monolithic spectrometer such as the S2000 spectrometer provided by Ocean Optics Inc.

There are a few preferred ways to determine the authenticity of the paper product 12 having taggants 14 located within the paper product coating 16. Namely, (1) simple visual inspection of the fluorescence color or (2) comparison to a standard may be sufficient to authenticate the item. A third and more rigorous analysis would include the use of a spectrometer based detection system. Analyzing features such as the peak emission wavelength and the wavelengths of the half intensity points would confirm the authenticity of the fluorescence signature. Fourth, one could use a detection based system such as a CCD array. The spectrometer or CCD based detection systems mentioned above can also be in the form of a hand held reader for authenticating the paper products 12. Further, any other methods known in the art to achieve the above objectives of the present invention may also be used.

In a second embodiment of the present invention, the long UV fluorescent phosphor taggants 14 are incorporated into a starch coating or solution 16. Label stock and packaging board 12 are often coated with starch sizing to improve the ink reception of the substrate. The starch coating 16 provides another approach to incorporate the security taggants onto the board 12.

In this embodiment, the same milled aqueous dispersion described above for the Long UV taggants for incorporation into the clay coating 16 is prepared and then added to the starch coating 16. The milled taggant aqueous dispersion that is incorporated into the starch coating 16 is done so preferably using simple blade mixing equipment known in the art. Other equipment known in the art for incorporating the aqueous dispersion of taggants 12 may also be used as well. The starch coating 16 is doped at a level of phosphor such that the finished board contains a phosphor loading ranging from 0.005% to 0.1% (percentage of the starch coating).

The starch coating 16 is typically a few percent (0.5%-5%) starch in water. The amount of phosphor in the solution depends upon the amount of phosphor per square area of board 12 that gives the desired effect. The preferred range for the long UV phosphors is 0.02-0.04 grams per square meter. The widest range could extend from 0.005-0.2 grams per square meter. The phosphor loading of the starch coating 16 will be adjusted based on the coat weight that is applied in order to achieve the desired amount of phosphor per board 12 area. This application is also used in the coating of label stock 12.

The starch coating 16 having the incorporated taggants therein is preferably applied by spray booms or dip tanks known in the paper industry. Other apparatus and methods known in the paper making industry for applying starch coating may also be used in accordance with the present invention because the taggants incorporated into the starch coating do not change the normal functioning of the starch coating 16 used in paper making. In a preferred approach the security taggant is soaked into the substrate by dipping the paper product into a dip tank containing the starch coating 16 described above. Such an approach is readily identified from attempts to imitate the feature by printing on the surface of a packaging board.

Detection/authentication of the paper products having the starch/taggant coating 16 thereon is accomplished in the same manner as discussed for the long UV taggants in the clay coating 16.

In a third embodiment of the present invention, short UV fluorescent security taggants 14 phosphors, which emit bright visible colors under excitation at UV wavelengths of about 220 nm to about approximately 310 nm, are incorporated into a clay coating 16, e.g. kaolin or calcium carbonate. This is done in the same way as is done for long UV phosphors of the first embodiment. Since short UV fluorescent materials and short UV excitation sources are less prevalent, the use of these materials provides additional security as compared to long UV fluorescent systems. A red emissive short UV system, e.g. Eu:Y₂O₃ (Europium doped yttrium oxide), can be milled down to an appropriate particle size (<10 microns) and blade mixed into the clay slurry. This short UV red material may be purchased from United Mineral Corporation.™

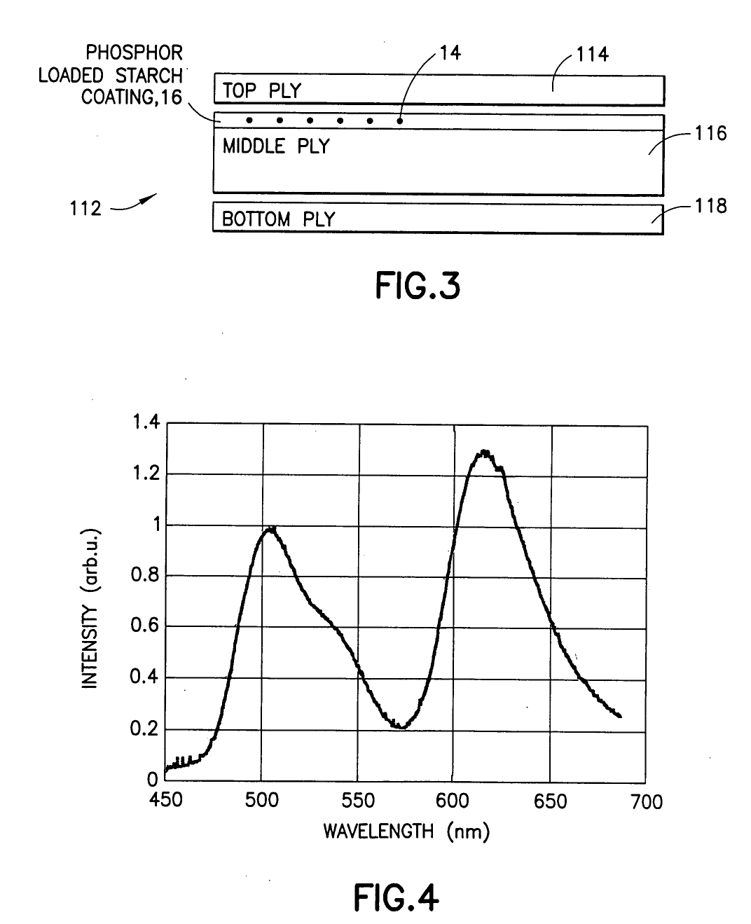

In a fourth embodiment of the present invention illustrated in FIG. 3, the security taggant 14 may be applied in between some or all of the board layers of a multi-ply board 112. A multi-ply board 112 that consists of two or more plies may be used in accordance with the present invention. The multi-ply board 112 is preferably comprised of three plys as illustrated in FIG. 3. The board consists of a top ply 114, a middle ply 116 and a bottom ply 118.

The aqueous dispersion of the security taggants 14 prepared for incorporation into the clay or starch coating 16 described above for any of the prior embodiments may likewise be used in this fourth embodiment. The aqueous dispersion of security taggants is next incorporated into a starch coating 16 in the same manner as set forth in the second embodiment. The starch/taggant coating 16 is then applied in between some or all of the plys of the multi-ply board 112 using a spray boom or a size tank which are both frequently used to apply additives such as starch coatings during paper manufacturing.

In one embodiment, the starch/taggant coating 16 is applied to the top of the middle ply 116 using a spray boom, prior to assembly of the board 112. In another embodiment, the starch/taggant coating 16 is sprayed onto the bottom of the top ply 114. In another embodiment the starch/taggant coating 16 is sprayed onto the top of the bottom ply 118. In yet another embodiment, the starch/taggant coating 16 is sprayed onto the bottom of the top ply 114, the top of the middle ply 116 and the top of the bottom ply 118. In other embodiments, the aqueous dispersion of the taggant is sprayed directly onto any or all of the above mentioned plys without being incorporated into a starch coating 16. In yet another embodiment the middle ply 116 is dipped into a size tank containing either the taggant/starch solution 16 or only the taggant aqueous dispersion. As in all of the embodiments of the present invention, the exact loading will depend upon the power of the interrogating light source, the fluorescence efficiency of the taggant, and the desired visual effect. The above application of the coatings all take place prior to the assembly of the multi-ply board 112.

It is also noted that depending upon the amount of material applied to the ply and the application method, it is possible to create an optically active feature that can either be viewed through the top of the board 112 or only along the edge by an inspection of the board cross section. For example, the taggant/starch coating 16 or taggant aqueous dispersion could be sprayed onto the top of the middle ply 116 of the three ply packaging board 112. If a low concentration (0.05-0.5 by dry weight percent of the middle ply 116) of the phosphor were applied and if the covering board plies were of a sufficient grammage (30-100 gsm), the fluorescence could only be detected under long UV excitation when the cross section of the board 112 was illuminated. Again, the exact loading will depend upon the power of the interrogating light source, the fluorescence efficiency of the taggant, and the desired visual effect. Such an application will defeat any attempts to mimic the feature by printing on top of non-secure board.

In a fifth embodiment of the present invention, small, individually observable security taggant particles 14 are incorporated into a clay coating 16. However, these particle taggants 14 may also be incorporated into starch coatings 16 or any other paper coating known in the art used in conjunction with paper products such as board stock and label stock.

In this embodiment, small (<10 μm) particles 14 of different fluorescence colors are added into the clay coating 16 to create security codes through the use of different color combinations and ratios of the fluorescent particles. These materials may be visibly colored or more preferably are invisible under ambient light conditions such as those provided by Spectra Systems Corporation under the trade name μDiscrete®. In order for these particles 14 to be consistent with the blade coating application method for the clay coatings 16, the maximum particle size must be less than 10 microns. Moreover, in order for these particles 14 to be identified under microscopic evaluation the particles should be greater than 1 micron in size. These phosphor doped polymer particles 14 are preferably blade mixed into the clay coating 16. However, other methods known in the art for incorporating these small phosphor doped particles 14 into the clay coating 16 may also be used. At high enough densities (>0.5% on a solids basis) it is possible to create what appears to the eye to be a uniform fluorescence under long UV excitation. Under microscopic evaluation individual particles 14 may be seen.

In other embodiments, numerous coding possibilities exist such as simple ratios of the particles (1:1:1 blue:green:red for example). In another embodiment, only a small amount of one material (˜1%) is used such that the uniform fluorescence appears one color but under long UV excitation and microscopic evaluation the fluorescent particles 14 which are present in a trace amounts can be detected.

Further in a sixth and seventh embodiment of the present invention, taggants are used in combination with absorbing and/or fluorescent ink pigments resulting in an interaction between the taggants and pigments to produce a detailed unique fluorescent signature which would not have been obtained otherwise but for this combination. In this regard, one can tailor or alter the light emission (fluorescence signature) given off from a paper product and create novel optical effects by selecting certain combinations of taggants and absorbing and/or fluorescing ink pigments to produce a desired fluorescence signature. The detailed fluorescence signature produced by the interaction between the selected taggants and ink pigments is preferably analyzed for authenticity using a spectrometer based or spectrally sensitive (combination of narrow band filters and photodetectors) reader. The fluorescence of these security systems may be activated by wavelengths in the range of from about 200 nm to about 5 microns.

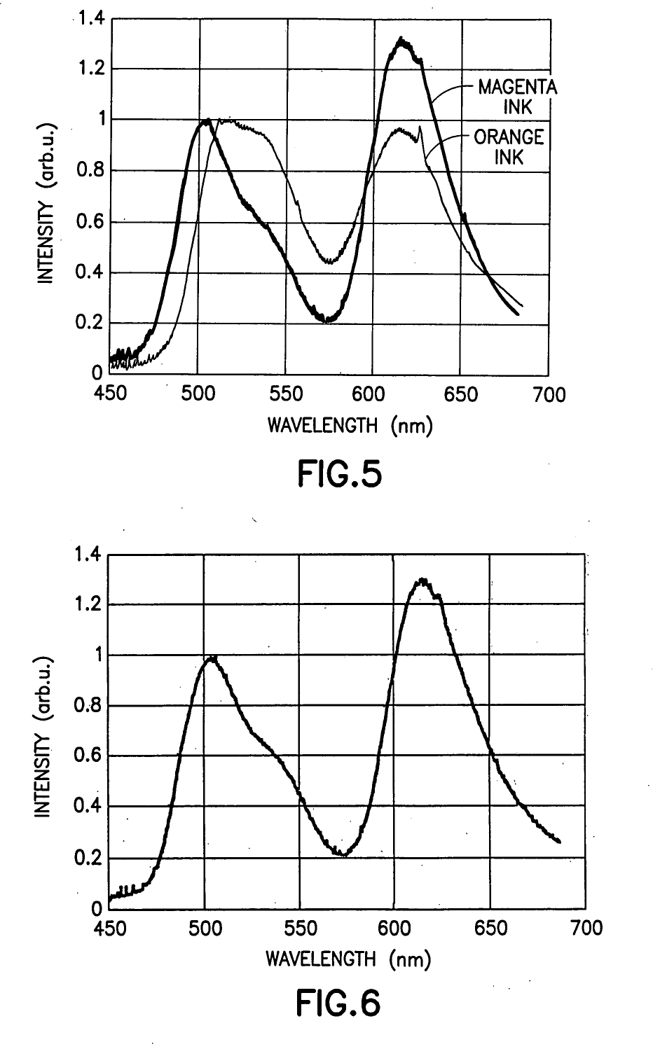

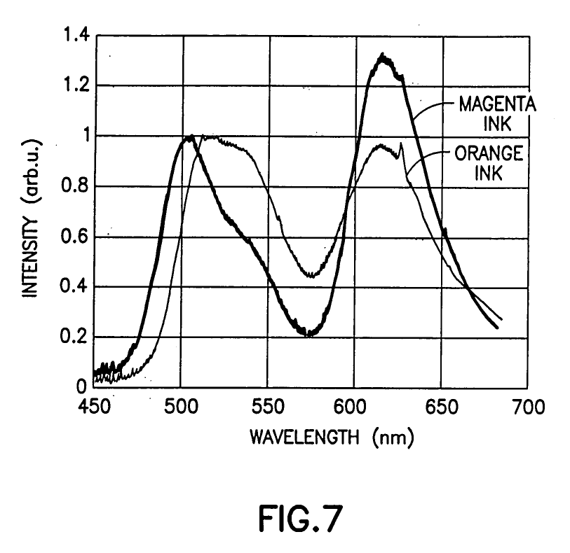

In one sub-embodiment, one or more fluorescent pigments in the ink interact with one or more selected taggants by at least partially absorbing a fluorescence emitted by the one or more taggants incorporated into the paper product coating. The fluorescence which is at least partially absorbed by the pigments causes a second fluorescence to be emitted by the one or more fluorescent pigments, thereby creating a unique spectral emission (see FIGS. 4 and 5). In a second sub-embodiment, one or more absorbing non-fluorescent pigments are added to the ink of the first sub-embodiment to further alter the spectral emission given off by the first sub-embodiment (see FIGS. 6 and 7). In this second sub-embodiment, unlike the first sub-embodiment, the pigments and taggants are each excited by the same excitation source and thus none of the pigments and/or taggants require the emission of the other for their fluorescence to be seen. The above combinations may be provided, for instance, in a paper coating and paper ink, wherein taggants are incorporated into the paper coating and interact with pigments located in the ink. Alternatively, the entire interaction between the selected taggants and the ink pigments may take place within the ink, without any taggants being incorporated within the paper product coating. A more detailed discussion of these different embodiments is set forth below.

Namely, FIGS. 4 and 5 illustrate the sixth embodiment of the present invention which involves the interaction of taggants 14 in the clay or starch coating 16 on the paper surface, e.g. packaging board with absorbing and/or fluorescent pigments and/or taggants in an ink applied on top of the coating. This embodiment illustrates that the effectiveness of taggants in security inks can be enhanced further if the taggants are used in combination with ink pigments. A similar approach is described in U.S. Patent Application Ser. No. 60/544,175 which is hereby incorporated by reference in its entirety, except in this embodiment interaction between taggants 14 and pigments is limited to the ink only with no taggants 14 being located in the clay or starch coating 16 of a paper product 12.

By way of example, in one preferred embodiment, the UV fluorescence from one material located within the clay coating 16 on board 12 is able to excite the fluorescence of a second fluorophor located within an ink applied on top of the clay coating, thereby forming a complicated spectral emission which can only be formed by the combination of the two fluorophors in the correct ratio as determined by the manufacturer for the customer's preference. In particular, this example relates to a clay coated packaging board 12 which was doped with a long UV green fluorescent taggant, with a magenta body color ink printed on top of the board. The red pigment in the ink was selected based on its fluorescence properties. Under long UV excitation the magenta pigment is not fluorescent. When irradiated by visible radiation in the green portion of the spectrum a red fluorescence is emitted. The UV excitation is able to penetrate the magenta ink and excite the green UV fluorescent taggant 14 in the underlying substrate. The green emission in turn excites the red fluorescence from the magenta taggant 14. Under visual observation the colors mix to create an orange/rust fluorescence color. Analysis by a spectrometer based reader, however, reveals a complicated fluorescence spectra characterized by two distinct fluorescence peaks. FIG. 4 illustrates the above mentioned spectra created by the clay coated packaging board 12 which was doped with a long UV green fluorescent taggant 14 with the magenta ink applied on top of the clay/taggant coating 16.

In other embodiments, additional fluorescent or absorbing pigments can be added to such a system to alter the emission spectrum and increase further the difficulty in mimicking such a feature. Other taggants 14, such as upconverting phosphors or photochromic materials, may also be added to these multi-component systems to further alter the fluorescence signature. FIG. 5 illustrates the effects of adding a yellow, non-fluorescent pigment to the same magenta ink discussed above and illustrated in FIG. 4 to create an orange ink with a different fluorescence signature. Since the yellow pigment absorbs wavelengths in the blue portion of the spectrum (<500 nm), the resulting fluorescence is different from that observed in the magenta ink. To the naked eye, a different shade of orange/gold fluorescence is observed. To the detector, the fluorescence signature has also been changed with the most noticeable difference being the peak position and shape of the fluorescence band in the 450-575 nm region.

It is also noted that the taggant/clay or taggant/starch coatings 16 are prepared and applied to the paper product 12 in the same manner as discussed in the first three embodiments of the present invention.

As mentioned above, the distinct fluorescent signature for enhancing the security features of a paper product 12, e.g. label stock or board stock can also exist in an ink alone embodiment without the incorporation of taggants 14 into a paper product coating 16. It is noted, however, that the ink/paper product coating embodiments provides additional measures of security over the ink alone embodiment as is reasonably clear from the present disclosure.

FIGS. 6 and 7 illustrate the ink alone embodiment (the seventh embodiment of the present invention) having one or more taggants 14 interacting with one or more ink pigments to produce a desired fluorescent signature as an added measure of security for label and/or board stock. However, the ink alone embodiment is not limited to label or board stock but rather may be applied to numerous other substrates. These inks can be printed onto documents of value, the foils used to seal blister packaging, or plastic film used to wrap the packaged item. These examples illustrate the wide array of uses for these security inks and in no way limit their uses to these applications.

The taggant/ink alone embodiment functions in basically the same manner as the above embodiment relating to incorporating the taggants into paper product coating (clay or starch) 16, except that in the ink alone embodiment the taggant ink pigment interaction takes place in the ink only. As will be illustrated below using the same taggant/ink combination(s) as described above in the paper product coating embodiment, the exact fluorescent signatures are produced. It is further indicated that the coatings do not affect the reactivity of the taggants with the ink pigments.

Specifically, FIG. 6 illustrates the dual fluorescence observed from a long UV green emitting phosphor which has been milled into a magenta offset ink. The magenta is non-fluorescent under long UV excitation and fluorescent under excitation by green. To the eye an orange/gold fluorescence color is observed when the inked region is excited by UV radiation. To a spectrometer based detection system, however, one observes that the orange fluorescence is actually the result of the green and red emissions color mixing. The detector would authenticate the ink by confirming some or all of the following: wavelengths of the peaks, wavelengths of the 50% transmission points, or relative peak heights. This the same fluorescent signature curve obtained for the paper coating/ink embodiment depicted in FIG. 4.

As in with the papercoating/ink embodiment, further complexity can be created in another ink alone embodiment by the addition of other pigments which absorb some of the fluorescence. In particular, FIG. 7 depicts the effects of adding a yellow, non-fluorescent pigment to the same magenta ink to create an orange ink with a different fluorescence signature. Again, since the yellow pigment absorbs wavelengths in the blue portion of the spectrum (<500 nm) the resulting fluorescence is different from that observed in the magenta ink. To the naked eye, a different shade of orange/gold fluorescence is observed. To the detector, the fluorescence signature has been also changed with the most noticeable difference being the peak position and shape of the fluorescence band in the 450-575 nm region. This is the same fluorescent signature curve obtained for the paper coating/ink embodiment depicted in FIG. 5.

As mentioned in the embodiment above, other pigments, such as upconverting and photochromic materials can be added to these multi-component systems to further alter the fluorescence signature. One skilled in the art based upon the present disclosure and knowledge of the science of spectral emissions could readily design an interacting taggant/pigment system such as those discussed in the sixth and seventh embodiment to produce their own desired fluorescent signatures for authenticating paper products.

It is further noted that coding schemes such as those already mentioned in the fifth embodiment or alternatively any other coating schemes known in the art may be used in conjunction with the present invention, such as in any of the embodiments already mentioned herein.

By way of example, possible other coding schemes which could be used in conjunction with embodiments of the present invention are described below. In particular, taggants 14 such as the small particles referred to in the fifth embodiment of the present invention could be incorporated into either a clay or starch paper product coating 16 using methods already discussed herein for placement on a paper product 12 or 112. Further, these taggants particles 14 could be specifically designed so as to create certain coding schemes. Namely, these taggant particles 14 can be created for incorporation into the paper product coating 16 having different particle sizes ranging from about 1 to about 10 microns. For example, if particles with four different particle size dimensions are used in combination with five wavelength ranges of UV fluorescence, up to 4⁵, or 1024 codes can be created. By applying various taggant particle combinations into the paper product coating, a post manufacturing code can be created.

Even more codes are possible by combining other attributes, such as diameter and shape. For example, using four diameters and five frequency ranges yields D^{F} (4⁵), or 1024 codes.

In addition, the loading factors of various taggants can be employed as a further variable. For example, there may be a set of taggants 14 having two members, the first comprised of red particles of 5 micron diameter and the second comprised of a red (or green, or blue, or yellow) particle having an 8 micron diameter. The first particles may be present with a loading factor of e.g. 10 taggant particles per square centimeter, while the second particles may be present with a loading factor e.g. of 15 taggant particles per square centimeter. By counting the numbers of particles per unit area of each type, it is possible to determine the information encoded by the selected taggants, e.g. taggant particles. For example, a paper product having this particular set of taggants is identified as a first type of paper product, while another paper document having a different set of taggants (e.g., red particles of 2 micron diameter and 8 micron diameter with loading factors of 10 per square centimeter and 15 per square centimeter, respectively) is identified as a second type of paper product. Furthermore, one may verify the authenticity of the paper product by verifying that the expected set of taggants particles are actually present with the expected size ranges and loading factors.

The decoding or identification of a code may involve imaging the taggants 14, analyzing the fluorescent emission and/or measuring the visible body color of the marking. For the example including polymer particles as taggants, they can be imaged by a CCD camera based system which uses spectral band base filters to transmit the fluorescence from the taggants and reject the excitation wavelengths. The spectral properties of the security marking can be analyzed by a spectrometer based reader system or by a reader which relies upon a series of photodectors and spectrally narrow (bandwidths of 10-20 nm) bandpass filters. The color of the marking can be determined approximately by a visual comparison to a standard or more accurately by a colorimeter.

Examples I and II illustrate the preparation and use of the sixth embodiment (ink/paper product coating embodiment) and seventh embodiment (ink alone), respectively, of the present invention which each relate to a security system of interacting taggants for paper products as a deterrent to counterfeiting.

### Example I

This Example sets forth the preparation and use of the sixth embodiment of the present invention which again involves the interaction of taggants incorporated within the clay or starch coatings on the paper product, e.g. packaging board with absorbing pigments and/or taggants in an ink applied on top of the coating. In this example we have selected an offset ink to interact with the taggant or taggants which are incorporated into the paper product coating. The pigment(s) can be applied in a variety of other vehicles such as gravure inks, flexographic inks, intaglio inks, varnishes, and adhesives to name a few. The following example in no way limits the number of possible carrier systems for the taggants.

Table 1. lists components of a typical sheet-fed quickset offset lithographic ink along with the approximate concentrations and purpose within the formulation for each of the components. Making the ink from these components is very straight forward for those skilled in the art. The ink manufacturing process involves the blending of the components in a roll mill in order to ensure the homogeneity of the viscous inks.

TABLE 1

| | Typical Ranges | | |
|---|---|---|---|
| | (measured in | | |
| | weight % of | | |
| | finished ink) | | |
| Component | Min | Max | Purpose |
| Pigment Orange 34 | 10.0 | 35.0 | visual color |
| (Aakash Chemicals) | | | |
| Solvar™ (Lawter) | 15.0 | 60.0 | Stabilize pigment dispersion |
| | | | and dilute |
| Tung Oil | 2.0 | 15.0 | Film former/hardener |
| 6% Cerium Drier | 0.2 | 1.0 | Accelerate drying |
| 12% Manganese Drier | 0.2 | 1.0 | Accelerate drying |
| 6% Cobalt Drier | 0.1 | 1.0 | Accelerate drying |

First, all of the liquid components are weighed out and added together in a container. This can be mixed together on the roll mill but it is often more efficient to simply premix them with high shear mixer. Next, the dry pigment(s) are milled into the resins. Premixing with high shear mixers can again speed up the milling time required on the roll mill. The proper resin(s) must be selected so that they will wet-out the pigment(s) aiding in milling and dispersion stability. The material is recycled back into the roll mill until the proper grind of the pigment is achieved, typically >7 on the Hegmann scale. Those skilled in the art can quickly arrive at the optimum combination of mixing processes.

Alternatively a pigment flush could be used or the dry pigment(s) can be mixed into one or two resins ahead of time at higher concentrations of around 38-60%. These pigment concentrates are then let down into the final ink with the appropriate amount of remaining resins. This allows the manufacturer to reduce the frequency of working with the dry pigment which is laborious to work with and clean up.

Further, the driers are added, and they are often premixed ahead of time. The driers are added last because they will start to crosslink the resins and build ink viscosity which can result in a reduced shelf life.

Ink properties are then measured to ensure quality. Proofs are made and the visual color is compared to a standard either visually and/or quantitatively with a densitometer or spectrophotometer or calorimeter. Ink tack is then measured with an inkometer. Necessary adjustments are made and then the ink is packaged for transfer to the printer/press.

When this ink is printed onto a substrate which has a suitable phosphor, such as Day-Glo™ invisible yellow D-034, doped into the clay the complex emission spectrum can be generated under long UV excitation.

The taggant system prepared above could then be used to authenticate the selected paper product by excitation devices as already discussed herein, such as UV lamps or a strobe system. Detection of the emissions could then be accomplished for example by using a combination of the naked eye and/or a spectrometer based detection unit to authenticate the fluorescence signature.

Additionally, different codes can be generated by varying both visible pigment and fluorescent colorant. Examples of other code combinations with illustrative concentrations include but are not limited to:

TABLE 3

| | Min | Max |
|---|---|---|
| Pigment Red 168 (Clariant) | 10.0 | 35.0 |
| DayGlow Invisible Yellow (#D-034) | 1.0 | 24.0 |

TABLE 4

| | Min | Max |
|---|---|---|
| Pigment Red 202 (Ciba) | 10.0 | 35.0 |
| Eastwell Papilion S-series | 6.0 | 32.0 |

The concentration ranges for each of the above components of the ink where set forth as the weight percent % of the finished ink.

### Example II

This Example sets forth the preparation and use of the seventh embodiment of the present invention which involves the interaction of selected taggants and ink pigments within the ink alone, without the incorporation of any taggants in the paper product coating. The preparation of the paper inks in this Example are very similar to the preparation of the inks described in the prior Example relating to the paper product coating/ink interaction, except that in the prior Example a taggant was present in the paper coating only and not in the overlying ink. However, as is clear from the above description, this is but one possible example and that selected taggants used in accordance with the sixth embodiment of the present invention may be included in both the ink and the coating for interaction with one another and with pigments located within the ink.

Table 5 lists components of a typical sheet-fed quickset offset lithographic ink along with there approximate concentrations and their purpose within the formulation. Making the ink from these components is very straight forward for those skilled in the art. The components are mixed together with a roll mill, thus, ensuring homogeneity of the viscous inks.

TABLE 5

| | Typical Ranges | | |
|---|---|---|---|
| | (measured in | | |
| | weight % of | | |
| | finished ink) | | |
| Component | Min | Max | Purpose |
| Pigment Orange 34 | 10.0 | 35.0 | Visual color |
| (Aakash Chemicals) | | | |
| Floures. Brightner 28 | 4.0 | 34.0 | Covert security |
| (Aldrich) | | | |
| Solvar™ (Lawter) | 15.0 | 60.0 | Stabilize pigment dispersion |
| | | | and dilute |
| Tung Oil | 2.0 | 15.0 | Film former/hardener |
| 6% Cerium Drier | 0.2 | 1.0 | Accelerate drying |
| 12% Manganese Drier | 0.2 | 1.0 | Accelerate drying |
| 6% Cobalt Drier | 0.1 | 1.0 | Accelerate drying |

Initially, all of the liquid components are weighed out and added together in a container. This can be mixed together on the roll mill but it is often more efficient to simply premix them with high shear mixer. Next, the dry pigment(s) and fluorescent colorant(s) are milled into the resins. Premixing with high shear mixers can again speed up the milling time required on the roll mill. The proper resin(s) must be selected so that they will wet-out the pigment(s) aiding in milling and dispersion stability. The material is recycled back into the roll mill until the proper grind of the pigment is achieved, typically >7 on the Hegmann scale. Those skilled in the art can quickly arrive at the optimum combination of mixing processes.

Alternatively a pigment flush could be used or the dry pigment(s) and fluorescent colorant(s) can be mixed into one or two resins ahead of time at higher concentrations of around 38-60%. These pigment concentrates are then let down into the final ink with the appropriate amount of remaining resins. This allows the manufacturer to reduce the frequency of working with the dry pigment which is laborious to work with and clean up.

Further, the driers are added, and they are often premixed ahead of time. The driers are added last because they will start to crosslink the resin(s) and build ink viscosity, which can shorten the life of the unprinted ink.

Ink properties are then measured to ensure quality. Proofs are made and the visual color is compared to a standard either visually and/or quantitatively with a densitometer or spectrophotometer or colorimeter. From the proofs, the amount of fluorescent colorant can also be checked to ensure that the proper amount was added. Ink tack is then measured with an inkometer. Necessary adjustments are made and then the ink is packaged for transfer to the printer/press.

Next, the prepared ink with the incorporated pigment, e.g. pigment Orange 34 (Askash Chemicals) and selected taggants is then applied onto the paper product coating located on the substrate of the paper product, as is routinely done in the paper making art.

The taggant system prepared above could then be used to authenticate the selected paper product by excitation devices as already discussed herein, such as UV lamps or a strobe system. Detection of the emissions could then be accomplished for example by using a combination of the naked eye and/or a spectrometer based detection unit to authenticate the fluorescence signature.

Finally, different codes can be generated by varying both visible pigment and fluorescent colorant. Examples of other code combinations with illustrative concentrations include but are not limited to:

TABLE 6

| | Min | Max |
|---|---|---|
| Pigment Red 168 (Clariant) | 10.0 | 35.0 |
| DayGlow Invisible Yellow (#D-034) | 1.0 | 24.0 |

TABLE 7

| | Min | Max |
|---|---|---|
| Pigment Red 202 (Ciba) | 10.0 | 35.0 |
| Eastwell Papilion S-series | 6.0 | 32.0 |

The concentration ranges for each of the above components of the ink where set forth as the weight percent % of the finished ink.

Although particular embodiments of the invention have been described in detail for purposes of illustration, various modifications and enhancements may be made without departing from the spirit and scope of the invention. Accordingly, the invention is not to be limited except as by the appended claims.

1. A taggant security system for preventing the counterfeiting of goods associated with a paper product having a substrate, comprising:
a paper product coating located on said substrate of said paper product; and
one or more taggants incorporated within said paper product coating.

2. The taggant security system of claim 1, wherein said paper product is a packaging board.

3. The taggant security system of claim 1, wherein said paper product is a label stock.

4. The taggant security system of claim 1, wherein said one or more taggants comprise at least one of visible or invisible fluorescent dyes or phosphors, up-converting phosphors, phosphorescent materials, photochromic materials, thermochromic materials, polymer particles such as spheres or fibers which contain fluorescent or non-fluorescent pigments which are either visible or free of any body color, and mixtures thereof.

5. The taggant security system of claim 4, wherein said one or more taggants comprise at least one of long UV fluorescent phosphors, short UV fluorescent phosphors, fluorescent materials which are excited by visible or infra-red irradiation, upconverters and any mixtures thereof.

6. The taggant security system of claim 5, wherein said one or more taggants comprise long UV fluorescent phosphors.

7. The taggant security system of claim 5, wherein said one or more taggants comprise fluorescent materials which require excitation wavelengths in the visible or infra red.

8. The taggant security system of claim 5, wherein said one or more taggants comprise short UV fluorescent phosphors.

9. The taggant security system of claim 5, wherein said one or more taggants comprise upconverters.

10. The taggant security system of claim 1, wherein said paper product coating is either a clay or starch coating used in the paper making industry.

11. The taggant security system of claim 1, wherein said paper product coating is a clay coating comprising at least one of kaolin, ground calcium carbonate, and precipitated calcium carbonate.

12. The taggant security system of claim 11, wherein said clay coating has a solids concentration between 50% and 70%.

13. The taggant security system of claim 1, wherein said paper product coating is present in an amount of from about 2 grams per square meter (gsm) to about 16 grams per square meter (gsm).

14. The taggant security system of claim 1, wherein said one or more taggants incorporated into said paper product coating have a size of from about 0.01 microns to about 10 microns.

15. A taggant security system for authentication of a multi-ply packaging board, comprising:
a coating having one or more taggants incorporated therein; and
wherein said coating is located in an area within said multi-ply packaging board.

16. The taggant security system of claim 15, wherein said coating is a starch coating having said one or more taggants incorporated therein.

17. The taggant security system of claim 16, wherein said starch coating having said one or more taggants incorporated therein is located in between said multi-ply packaging board.

18. The taggant security system of claim 15, wherein said coating is an aqueous dispersion of said one or more taggants applied in between said multi-ply board.

19. The taggant security system of claim 16, wherein said starch coating is soaked within said multi-ply packaging board.

20. The taggant security system of claim 16, wherein said starch coating having said one or more taggants incorporated therein is applied in between said multi-ply packaging board via a spray boom.

21. The taggant security system of claim 19, wherein said starch coating is applied into said multi-ply packaging board via a dip tank.

22. The taggant security system of claim 15, wherein said one or more taggants comprise at least one of visible or invisible fluorescent dyes or phosphors, up-converting phosphors, phosphorescent materials, photochromic materials, thermochromic materials and polymer particles such as spheres or fibers which contain fluorescent or non-fluorescent pigments which are either visible or free of any body color, and mixtures thereof.

23. The taggant security system of claim 15, wherein said multi-ply board is comprised of a top ply, a middle ply and a bottom ply, and said coating is applied to the middle ply prior to assembly of the multi-ply board by one of a spray boon or a dip tank.

24. An interacting taggant security system for preventing the counterfeiting of goods associated with a paper product, comprising:
a paper product coating located on said paper product;
one or more taggants incorporated within said paper product coating;
at least one ink having one or more pigments therein, said at least one ink is located on top of said paper product coating; and
wherein said one or more pigments in said ink interact with said one or more taggants incorporated within said paper coating, thereby creating a unique spectral emission which would not have been caused otherwise but for said interaction.

25. The interacting taggant security system of claim 24, wherein said one or more pigments is a fluorescent pigment, and wherein said one or more fluorescent pigments in said ink interact with said one or more taggants by at least partially absorbing a fluorescence emitted by said one or more taggants, said fluorescence which at least partially absorbed by said one or more fluorescent pigments causes a second fluorescence to be emitted by said one or more fluorescent pigments, thereby creating a unique spectral emission.

26. The interacting taggant security system of claim 25, further comprising adding at least one absorbing non-fluorescent pigment to said ink to further alter said unique spectral emission.

27. An interacting taggant security system for preventing the counterfeiting of goods associated with a paper product, comprising:
at least one ink located on a paper substrate of said paper product, said ink having one or more pigments located therein;
one or more taggants located within said ink; and
wherein said one or more pigments in said ink interact with said one or more taggants in said ink, thereby creating a unique spectral emission which would not have been caused otherwise but for said interaction

28. The interacting taggant security system of claim 27, wherein said one or more pigments is a fluorescent pigment, and wherein said one or more fluorescent pigments in said ink interact with said one or more taggants by at least partially absorbing a fluorescence emitted by said one or more taggants, said fluorescence which is at least partially absorbed by said one or more fluorescent pigments causes a second fluorescence to be emitted by said one or more fluorescent pigments, thereby creating a unique spectral emission.

29. The interacting taggant security system of claim 28, further comprising adding at least one absorbing non-fluorescent pigment to said ink to further alter said unique spectral emission.

30. A method for preparing a taggant security system for authenticating a paper product, comprising:
preparing a preparation of one or more taggants for incorporation into a paper product coating that is used in the paper making industry; and
incorporating said taggant dispersion into said paper product coating.

31. The method of claim 30 further comprising:
applying said paper product coating to said paper product; and
authenticating said paper product.
